(19) United States
(12) Patent Application Publication
(10) Pub. No.: US 2010/0250134 A1
(43) Pub. Date: Sep. 30, 2010

(54) DEAD RECKONING ELEVATION COMPONENT ADJUSTMENT

(75) Inventors: Gilad Bornstein, Haifa (IL); Nir Strauss, Haifa (IL); Alecsander P. Eitan, Haifa (IL)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/410,316

(22) Filed: Mar. 24, 2009

(51) Int. Cl. G01C 21/00

(52) U.S. Cl. 701/220

(57) ABSTRACT

The subject matter disclosed herein relates to adjusting an elevation component of a estimated location based, at least in part, on sensor-based dead reckoning.

### BACKGROUND

1. Field

The subject matter disclosed herein relates to adjusting an elevation component of a estimated location based, at least in part, on sensor-based dead reckoning.

2. Information

Satellite positioning systems (SPS) such as, for example, the Global Positioning System (GPS), may provide reliable navigation in many circumstances. To gather information in order to determine a position location, a mobile device may receive timing signals from an SPS. Such information may be utilized by the mobile station to estimate the position location, or the mobile station may provide the information to a network entity for position location estimation. However, under some circumstances, the mobile station may encounter difficulties in receiving the signals. For example, difficulties may be experienced if the mobile station is positioned inside of a building. In such circumstances, data from sensors located in the mobile device may be used to perform dead reckoning navigation to update the mobile station's estimated location. However, dead reckoning through sensor data may incur some error. Measuring changes in elevation may prove to be particularly challenging, in at least some circumstances.

### SUMMARY

In one aspect, an estimated initial position for a mobile station may be determined, wherein the estimated initial position comprises an elevation component. Also, in an aspect, an interior feature of a building may be detected at least in part by detecting a change in position of the mobile station with respect to the estimated initial position. This detecting the change in position may be made in response to sensor data by detecting a change in the elevation component. In a further aspect, the detected change in the elevation component may be adjusted using information related to the detected interior feature.

### BRIEF DESCRIPTION OF THE FIGURES

Non-limiting and non-exhaustive examples will be described with reference to the following figures, wherein like reference numerals refer to like parts throughout the various figures.

FIG. 1 is a block diagram of an example satellite position system (SPS) and an example cellular network.

FIG. 2 is an illustration of a building having a location in an SPS coordinate system.

FIG. 3 is a block diagram of an example inertial measurement unit.

FIG. 4 is a flow diagram of an example process for adjusting a detected change in elevation.

FIG. 5 is a diagram illustrating an example inertial measurement unit with a plurality of degrees of freedom.

FIG. 6 is a block diagram of an example process for adjusting an elevation component of an estimated location.

FIG. 7 is an illustration depicting detection of a user moving in an elevator.

FIG. 8 is a diagram illustrating detection of a user climbing a flight of stairs.

FIG. 9 is a block diagram of an example mobile station incorporating an inertial measurement unit.

### DETAILED DESCRIPTION

Reference throughout this specification to “one example”, “one feature”, “an example” or “a feature” means that a particular feature, structure, or characteristic described in connection with the feature and/or example is included in at least one feature and/or example of claimed subject matter. Thus, the appearances of the phrase “in one example”, “an example”, “in one feature” or “a feature” in various places throughout this specification are not necessarily all referring to the same feature and/or example. Furthermore, the particular features, structures, or characteristics may be combined in one or more examples and/or features.

In one example, a device and/or system may estimate its location based, at least in part, on signals received from satellites. In particular, such a device and/or system may obtain “pseudorange” measurements comprising approximations of distances between associated transmitters and a navigation receiver. In a particular example, such a pseudorange may be determined at a receiver that is capable of processing signals from one or more space vehicles (SVs) as part of a Satellite Positioning System (SPS). Such an SPS may comprise, for example, a Global Positioning System (GPS), Galileo, Glonass, to name a few, or any SPS developed in the future. To estimate its position, an navigation receiver may obtain pseudorange measurements to three or more SVs as well as their positions at time of transmitting. Knowing the satellite's orbital parameters, these satellite positions can be calculated for any point in time. A pseudorange measurement may then be determined based, at least in part, on the time a signal travels from a satellite to the receiver, multiplied by the speed of light. While techniques described herein may be provided as implementations of location determination in a GPS, EGNOS, WAAS, Glonass and/or Galileo types of SPS as specific illustrations, it should be understood that these techniques may also apply to other types of SPS, and that claimed subject matter is not limited in this respect. For one or more embodiments, a location may comprise three elements (x, y, z), which may comprise, for an example, longitude, latitude, and elevation, which, in some circumstances, may be referred to as altitude.

As discussed above, under some circumstances, a mobile station may encounter difficulties in receiving signals for use in obtaining pseudorange measurements. For example, difficulties may be experienced if such a mobile station is positioned inside of a building. In such circumstances, data from sensors located in the mobile device may be used to perform dead reckoning navigation to periodically and/or continually update the mobile device's estimated location. However, dead reckoning through sensor data may incur some error, and measuring changes in elevation may prove to be particularly challenging, in at least some circumstances. In general, determining an elevation for a mobile station may be less accurate than what is generally possible with determinations of longitude and latitude.

In general, dead reckoning navigation may start with a known, or at least estimated, position. A subsequent position may be computed by identifying the displacement (distance and direction) from an initial previous position. Sensors, incorporated into an inertial measurement unit in one example, may provide the distance and direction information. As mentioned, dead reckoning has a drawback in that displacement and heading errors accumulate over time. The amount of error may depend, at least in part, on the accuracy of the sensors and on how often measurements are taken. More frequent measurements may generally result in fewer errors, while the error may increase overall as time passes and as relatively small errors are compounded with further error as additional measurements are taken.

Short time-measurement intervals may help to improve accuracy, as do accurate sensors to track distance and direction. However, various aspects described herein discuss techniques whereby relatively inexpensive and perhaps less accurate sensors may be utilized to perform dead-reckoning navigation operations, and errors may be compensated for, at least in part, through the techniques described herein.

As previously mentioned, for some mobile stations, sensors may be utilized to perform dead reckoning navigation to detect changes in elevation. Such sensors may include, for example, accelerometers and gyroscopes incorporated into inertial measurement units. However, inertial measurement units with sufficient accuracy to detect changes in elevation without excessive error in the absence of SPS signals may be relatively expensive, and/or may consume relatively large amounts of power. To address these issues, in an aspect, if the mobile station is inside of a building, any of a range of features of that building may be detected by the mobile station as a user of the mobile station moves around the building, and the detected features may be used to adjust changes in elevation measured by the mobile station. For example, if a mobile station detects that the user moved in an elevator from one floor to the next, a known or estimated vertical distance between the two floors may be used to adjust the change in elevation detected through dead reckoning by the mobile station, thus correcting, at least in part, for the accumulated error. Further examples and additional details are provided in the discussion that follows.

As used herein, the term “elevation” is intended to a vertical distance between one point of reference and another. For example, the term “elevation” may denote a vertical distance between an object and a ground level. For another example, the term “elevation” may denote an altitude between an object and sea level. For yet another example, if a staircase rises from a first level to a height of 10 feet above the first level, the staircase may be said to have an elevation of 10 feet. For a further example, if a staircase leads from a ground floor to a basement level 15 feet below ground level, the staircase may be said to have an elevation of 15 feet. However, these are merely example usages of the term “elevation”, and the scope of claimed subject matter is not limited in these respects. Also, as used herein, the term “acceleration” may refer to positive acceleration, and may also refer to negative acceleration, which may sometimes be referred to a deceleration. Further, it should be noted that calculating vertical distances may involve time measurements as well as accelerations. Given the vertical acceleration (or deceleration) and the amount of time transpired, a change in vertical distance may be calculated.

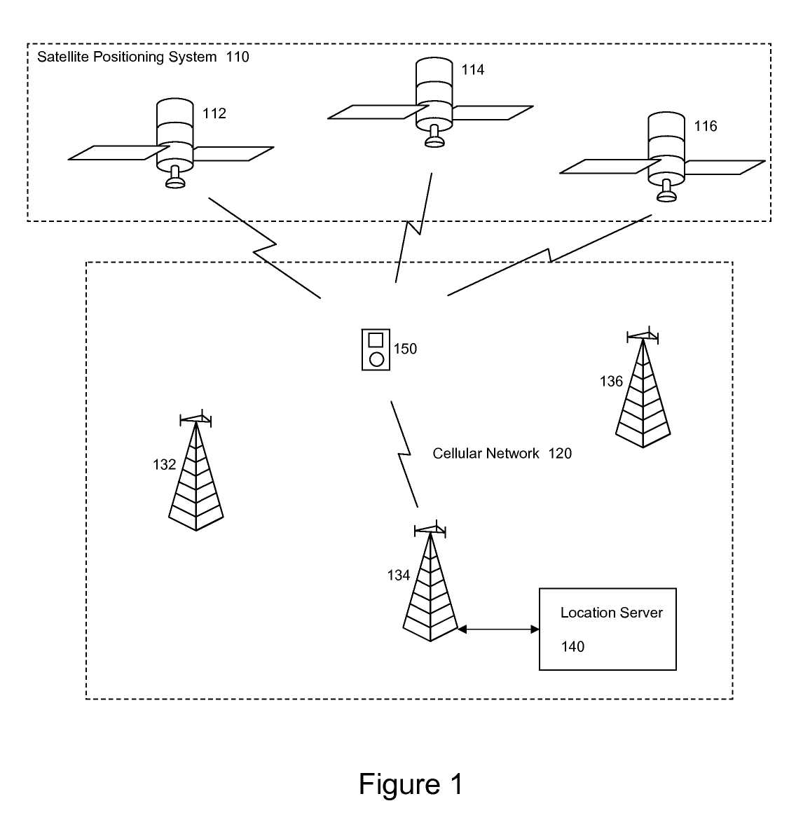

FIG. 1 is a diagram depicting an example cellular network 120 and an example satellite positioning system (SPS) 110. In an aspect, SPS 110 may comprise a number of SVs, for example SVs 112, 114, and 116. For an example, SPS 110 may comprise any of the several SPS such as GPS, Glonass, Galileo, etc., although the scope of claimed subject matter is not limited in this respect. For one example, cellular network 120 may comprise base stations 132, 134, and 136. Of course, other examples may include other numbers of base stations, and the configuration of base stations depicted in FIG. 1 is merely an example configuration. Further, as used herein, the term “base station” is meant to include any wireless communication station and/or device typically installed at a known location and used to facilitate communication in a wireless network, such as, for example, a cellular network. In another aspect, base stations may be included in any of a range of electronic device types. Also, although some example embodiments described herein mention communication transceivers and various networks, some embodiments may comprise mobile stations or other electronic device types that do not need to be connected to any network or other device in order to perform the elevation component adjustment operations described herein.

As used herein, the term “mobile station” (MS) refers to a device that may from time to time have a position location that changes. The changes in position location may comprise changes to direction, distance, orientation, etc., as a few examples. In particular examples, a mobile station may comprise a cellular telephone, wireless communication device, user equipment, laptop computer, other personal communication system (PCS) device, personal digital assistant (PDA), personal audio device (PAD), portable navigational device, and/or other portable communication devices. A mobile station may also comprise a processor and/or computing platform adapted to perform functions controlled by machine-readable instructions.

In one or more aspects, mobile station 150 may communicate with one or more of SVs 112, 114, and 116, as well as with base station 134. For example, mobile station 150 may receive signal propagation delay information from one or more of the SVs and/or the base station. However, as discussed previously, in some circumstances SPS signals may not be available. In such a circumstance, mobile station 150 may perform dead reckoning navigation to estimate changes in position, including, for an example, changes in elevation. Mobile station 150 may calculate a position location for the mobile station based, at least in part, on information generated by one or more sensors within the mobile station. Examples of measurements based on sensor information are provided in more detail below.

In another aspect, position location determination calculations may be performed by a location server 140 such as, for example, a position determination entity, depicted in FIG. 1, rather than at mobile station 150. Such a calculation may be based, at least in part, on information gathered by mobile station 150 from one or more of SVs 112, 114, and 116, as well as information related to one or more sensors for mobile station 150, for an example. In a further aspect, location server 140 may transmit the calculated position location to mobile station 150. Also, in another aspect, location server 140 may contain a database of information related to various features of one or more buildings that may be used to help adjust for accumulated error in elevation calculation during dead reckoning navigation operations, as discussed more fully below.

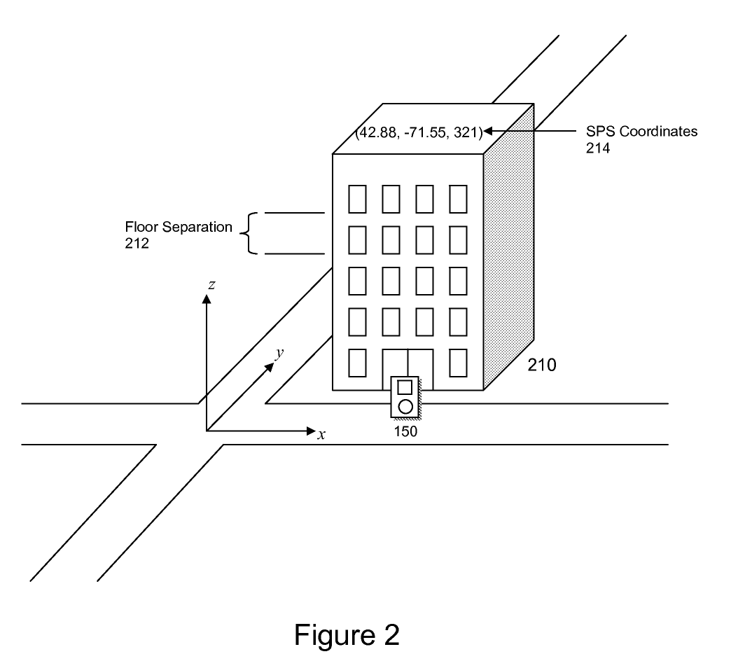

FIG. 2 is an illustration of a building 210 having a location 214 in an SPS coordinate system. For this example, building 210 has an estimated location of (42.88, −71.55, 321), presented as latitude and longitude GPS coordinates and an elevation with respect to sea level. Although the elevation element of the location is mentioned as referenced to sea level, other elevation references are possible, and the scope of claimed subject matter is not limited in this respect. In this example, the elevation is represented as meters above sea level, but again, the scope of claimed subject matter is not so limited. Also depicted in FIG. 2 is mobile station 150. If mobile station 150 is located outside of building 210, for example, it may be able to receive SPS signals from an SPS system, such as system 110, depicted in FIG. 1, and mobile station may calculate its estimated position based at least in part on the SPS signals in combination with information provided by PDE 140, for example. However, if a user carries mobile station 150 into building 210, SPS signals may not be available. In such a situation, mobile station 150 may perform dead reckoning navigation operations in an effort to track movements of the mobile station and to continually, or at least periodically update the mobile station's estimated location based on the measured movements. In an aspect, the estimated position of mobile station 150 may include an elevation component, and the dead reckoning navigation operations may attempt to track changes in elevation.

As previously mentioned, dead reckoning measurements as they relate to elevation changes may be subject to errors that may accumulate over time to produce inadequate accuracy in some circumstances. In one aspect, information related to building 210 may be used to adjust the change in elevation measurements made by mobile station 150. For example, assume that a user carries mobile station 150 into building 210, and that the user rides an elevator from the ground floor to the second floor. Mobile station 150 may perform dead reckoning calculations to estimate a change in elevation experienced as mobile station moved from the ground floor to the second floor. As previously described such measurement may incur cumulative errors. However, if the distance between two floors of building 210 is known, one may adjust the estimated change in elevation calculated by mobile station 150 to compensate for the accumulated errors. For the present example, the vertical distance between floors of building 210 is labeled in FIG. 2 by Floor Separation 212.

For the example given above, the vertical distance between floors of building 210 is a known value. However, in other examples, such information may not be known. In such situations, information from sensors and/or timers may be used to calculate estimated location changes, including changes in elevation. For example, if a user is riding an elevator from one floor to the next, the mobile station may calculate an estimated elevation change based on the speed of the elevator and on the amount of time elapsed during the journey. Of course, this is merely one example. For some examples, the distance between floors may be estimated, based, in at least some cases, on typical floor separation values observed for other buildings. For an example, buildings in a downtown area may be estimated to have one floor separation value, and buildings in a suburban area may be estimated to have another floor separation value. In one aspect, a database may be stored, wherein the database includes information for a number of buildings. In an example, the building may be associated with SPS coordinates so that a mobile device may be able to request the building information by referring to the building's coordinates. In another aspect, the types of information that may be stored for the buildings may include floor separation values, floor plans, information related to elevators, escalators, staircases, ramps, etc. For an example, with respect to a staircase, information may be stored related to the number of stairs and the average height of a single stair. Information related to the elevator may relate to rates of ascent and descent, acceleration information, etc. For one or more examples, given information related to one or more of the aforementioned interior features of the building, dead reckoning navigation operations may be enhanced and errors may be corrected, at least in part. Of course, although some embodiments described herein make use of external databases for building information, other embodiments are possible where the mobile station performs the elevation element adjustment operations without being connected to any network, and without accessing an external database.

In another aspect, information related to building 210 may not be available to mobile station 150. In this example, and as will be more fully discussed below, mobile station 150 may determine an estimated initial position. Such a position may be the last position determined with the aid of SPS signals before mobile station 150 enters building 210. Upon losing reception of the SPS signals, mobile station 150 may commence dead reckoning calculations and may make relatively frequent adjustments to the estimated location based at least in part on the dead reckoning operations. For the present example, assume that a user carries mobile station 150 into building 210 and proceeds to climb a staircase to the second floor. Mobile station 150 may detect that the user is climbing a set of stairs, and may, for one example, adjust the elevation component of the estimated position for mobile station 150 based on known or estimated qualities and/or characteristics of the staircase. Mobile station 150 may further utilize floor separation value 212 for one example to adjust the elevation component of the estimated position at least in part in response to the mobile station detecting the user climbing the staircase. Of course, a staircase is merely one example of an interior feature of a building that may be utilized to adjust position estimates in order to correct for accumulated errors, and the scope of claimed subject matter is not limited in these respects. In detecting the staircase, the signals from an inertial measurement unit (IMU), such as the example unit described below, may have a pattern that may be referred to as a “staircase”, so named because the signals may jump from value to value in a staircase fashion. This pattern may be similar to a walking pattern, but will have elevation change as well as lateral movement. Various IMU may exhibit their own individual patterns, and the patterns may be affected by the unit's tilt relative to the ground.

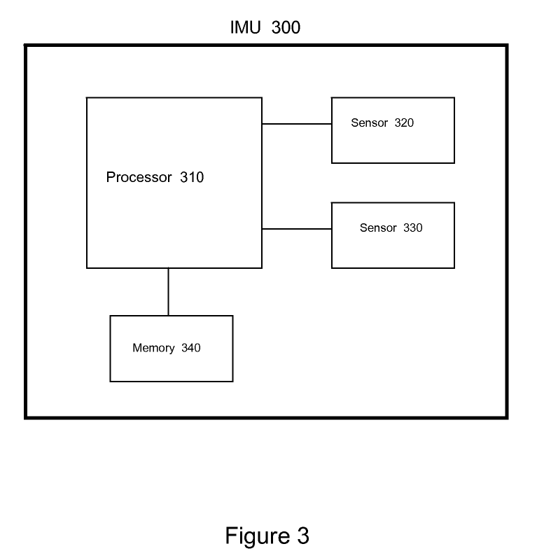

FIG. 3 is a block diagram of an example inertial measurement unit 300. IMU for this example comprises a sensor 320 and a sensor 330, as well as a processor 310 and a memory 340. For the present example, processor 310 may be dedicated to operations directly related to sensors 320 and 330, although the scope of claimed subject matter is not limited in this respect.

Sensors 320 and 330 may comprise any of a range of sensor types. A variety of sensors may be available to support a number of applications. These sensors may convert physical phenomena into analog and/or electrical signals. Such sensors may include, for example, an accelerometer. An accelerometer may sense the direction of gravity and any other force experienced by the sensor. The accelerometer may be used to sense linear and/or angular movement, and may also be used, for example, to measure tilt and/or roll. Yet another sensor type may include a gyroscope which measures the Coriolis effect and may be used in applications measuring heading changes or in measuring rate of rotation.

Another sensor type may include a barometric pressure sensor. A barometric pressure sensor may be used to measure atmospheric pressure. Applications for the barometric pressure sensor may include determining altitude. Other applications may include observing atmospheric pressure as it relates to weather conditions.

Another type of sensor may include a magnetic field sensor that may measure the strength of a magnetic field and, correspondingly, the direction of a magnetic field. A compass is an example of a magnetic field sensor. The compass may find use in determining absolute heading in car and pedestrian navigation applications.

Although the example of FIG. 3 depicts sensors 320 and 330 as being included with processor 310 in a in a discrete, separately packaged IMU 300, the scope of claimed subject matter is not limited in this respect, and other examples are possible using discrete sensors that are not packaged in an IMU.

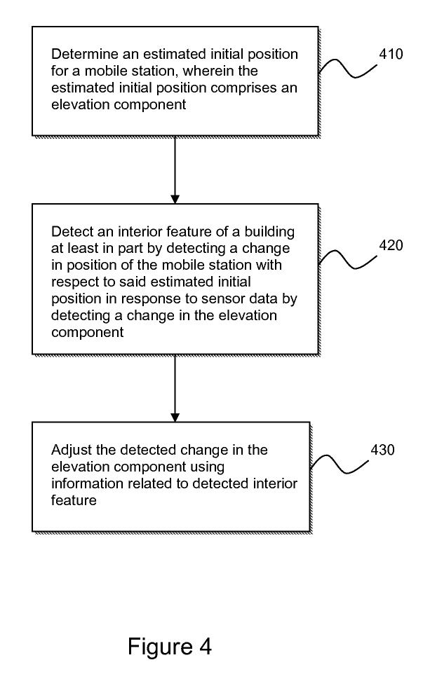

FIG. 4 is a flow diagram of an example process for adjusting a detected change in elevation in accordance with claimed subject matter. In an aspect, at block 410, an estimated initial position for a mobile station may be determined, wherein the estimated initial position comprises an elevation component. At block 420, an interior feature of a building may be detected at least in part by detecting a change in position of the mobile station with respect to the estimated initial position in response to sensor data by detecting a change in the elevation component. In another aspect, at block 430, the detected change in the elevation component may be adjusted using information related to the detected interior feature. Other example processes in accordance with claimed subject matter may include all, less than, or more than blocks 410-430. Further, the order of blocks 410-430 is merely an example order, and the scope of claimed subject matter is not limited in this respect.

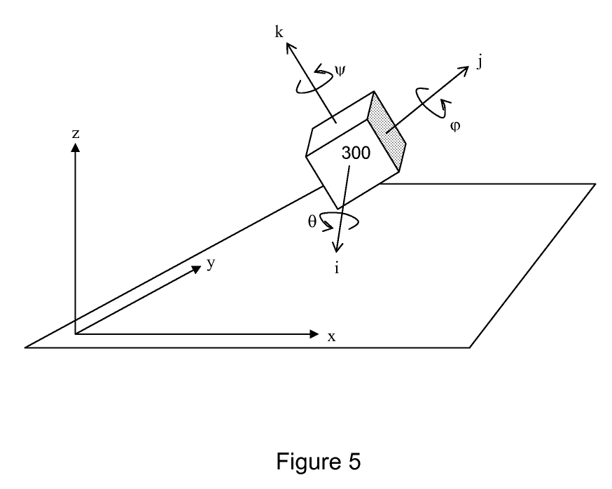

FIG. 5 is a diagram illustrating example IMU 300 with a plurality of degrees of freedom. As noted above, in navigation applications, accelerometers, gyroscopes, geomagnetic sensors, and pressure sensors may be utilized to provide various degrees of observability. In an aspect, IMU 300 may comprise at least one accelerometer and at least one gyroscope, although the scope of claimed subject matter is not limited in this respect. For one example, and as depicted in FIG. 5, the accelerometer and gyroscope may provide six axes of observability (i, j, k, θ, φ, ψ). As mentioned above, the accelerometer may sense linear motion (translation in any plane, such as a local horizontal plane). This translation may be measured with reference to at least one axis. The accelerometer may also provide a measure of an object's tilt (roll or pitch). Thus, with the accelerometer, an object's motion in Cartesian coordinate space (i, j, k) may be sensed, and the direction of gravity may be sensed to estimate an object's roll and pitch. The gyroscope may be used to measure the rate of rotation about (i, j, k), i.e., roll (θ) and pitch (φ) and yaw, which may also be referred to as azimuth or “heading” (ψ). Of course, IMU 300 merely represents on example, and the various degrees of observability are also merely examples. The scope of claimed subject matter is not limited to these specific examples.

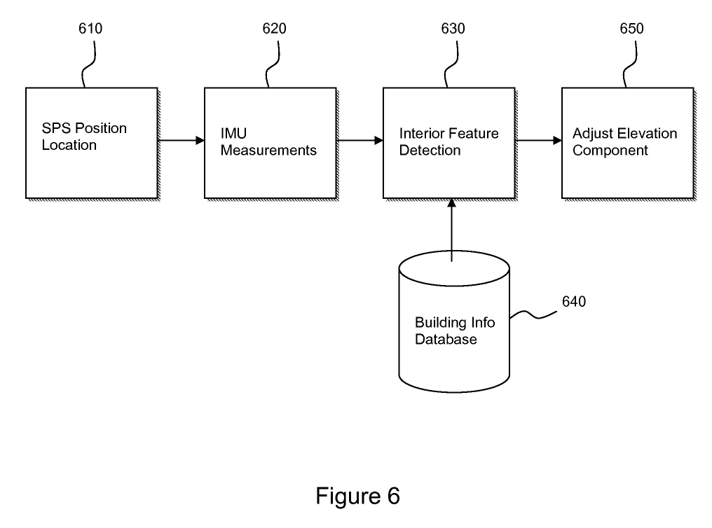

FIG. 6 is a block diagram of an example process for adjusting an elevation component of an estimated location. At block 610, an initial location may be estimated. For this example, SPS signals may be utilized by mobile station 150 to determine, at least in part, an estimated location for the mobile station. At block 620, SPS signals may not be available, in this example because a user has carried mobile station 150 into a building. In response to not being able to receive SPS signals, mobile station 150 may begin to perform dead reckoning, and may make a series of measurements to repeatedly update the estimated location. Mobile station 150 may continue to take measurements as the user meanders through the building.

At some point while in the building, the user may encounter one of a number of interior features of the building that may be recognizable by mobile station 150. For example, the user may take an escalator to move from one floor to another floor. Mobile device 150, through IMU 500, at least in part, may detect a pattern of motion matching a pattern one would expect to see for the user riding an escalator. The example interior feature detection process if depicted in FIG. 6 at block 630. In an aspect, mobile station 150 may match recent measurements from IMU 300 involving a suspected interior feature with patterns of measurement values known to represent different classes or types of interior features. That is, IMU measurement information for a user climbing a staircase looks different than the IMU measurement information for the user riding in an escalator, or walking up a ramp, for example.

As part of the interior feature detection process, mobile device 150 may access a database 640 of information related to the interior features of the building. For an example, the database may be stored at a network entity such as location server 140. Database 640 may comprise any of a wide range of information related to the interior features. For example, database 640 may include information related to the escalator mentioned above. Such information may include, for example, the vertical distance between floors in the building, the location of the elevator in the building, the acceleration/deceleration characteristics, and rates of ascent and descent for the elevator. Of course, these are merely example types of information, and the scope of claimed subject matter is not limited in this respect. Also, as mentioned previously, embodiments in accordance with claimed subject matter may not incorporate a database, and for some embodiments the mobile station may perform elevation element adjustment operations without being connected to any network and without accessing any external database. That is, the mobile station may perform these operations in a stand-alone fashion.

In an aspect, mobile station 150 may utilize the information from database 640 to adjust the elevation component of the mobile station's most recent estimated position. For the example of the elevator, if mobile station 150 detected that the user took the elevator up approximately one floor, database 640 may provide a value for the vertical distance between floors in that particular building, or for an average of buildings for another example, and the value for the vertical distance between floors may be used to adjust the elevation component of the mobile station's most recent estimated location, and in this manner the accumulated error from the dead reckoning computations may be compensated for.

In another aspect, database 640 may comprise information for a number of individually identifiable buildings, while in a further aspect the database may include averaged information meant to be utilized for a number of buildings. Also, although the present example depicted in FIG. 6 depicts a database for information related to interior features, other examples may not include such a database. For example, mobile station 150 may utilize only information gleaned from dead reckoning operations to detect interior features and to detect specific details regarding the detected features. For example, it may be possible to measure the height of individual stairs of a staircase using IMU data.

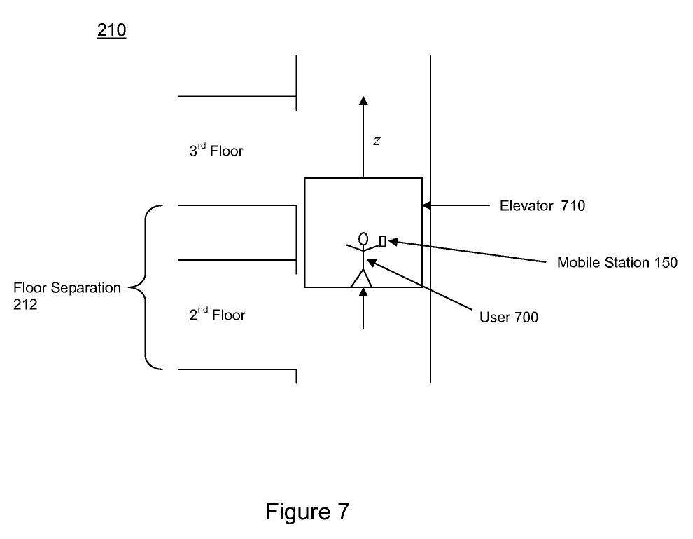

FIG. 7 is an illustration depicting detection of a user 700 moving in an elevator 710. For this example, user 700 is carrying mobile station 150. Also for this example, elevator 710 is located within building 210. For this example, it may be assumed that user 700 entered building 210 with a recent estimated location, and upon entering building 210, mobile station 150 began dead reckoning measurements, and the initial estimated location was frequently updated as dead reckoning measurement data became available. Of course, as noted previously, one potential drawback to dead reckoning is the error that is accumulated over time. Small errors in each measurement may compound each other until a larger error results.

For the example of FIG. 7, user 700 enters the elevator with a most recent estimated position that is based, at least in part, on previously obtained location information from an SPS system before entering the building, and on dead reckoning measurement information as the mobile station approaches the elevator. For this example, errors may have accumulated in the (x, y) plane. If a database, such as database 640, is available and includes information related to the location of the elevator within building 210, that information may be used to adjust the estimated location of mobile station 150. As elevator 710 begins its ascent from the 2^{nd} floor to the 3^{rd} floor, for this example, IMU 300 may provide sensor data, and a series of measurements are taken. With every measurement, for this example, the estimated location is updated to reflect the motion of mobile station 150, which for this situation is in only the vertical direction.

As dead reckoning measurements are taken, errors may accumulate, as previously described. Mobile station 150 may use known and/or estimated information related to the elevator to, at least in part, compensate for the accumulated error by adjusting the elevation component of the current estimated location. For example, a rate of ascent value, either measured or estimated, may be used to determine how far the elevator has changed in elevation from the last measurement, and the elevation component of the estimated location may be adjusted accordingly. Similarly, once the elevator has traveled the entire distance to the next floor and the mobile station detects that the elevator has stopped, floor separation value 212 may be used to adjust the elevation component of the estimated location to compensate for accumulated error.

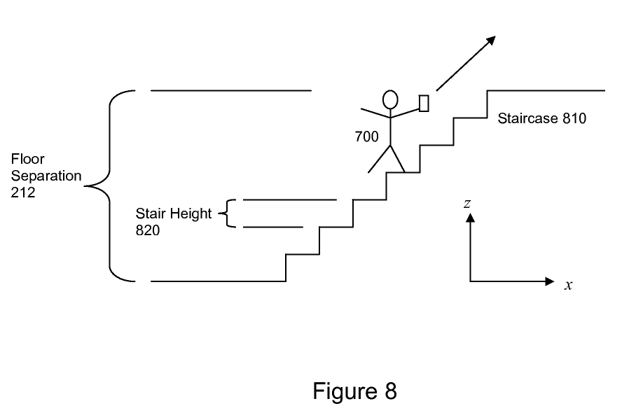

FIG. 8 is a diagram illustrating detection of a user 700 climbing a staircase 810. Much of the discussion above related to the elevator example of FIG. 7 may be applied to the staircase example. For this example, user 700 is again carrying mobile station 150. Also for this example, staircase 810 is located within building 210. For this example, it may be assumed that user 700 entered building 210 with a recent estimated location, and upon entering building 210, mobile station 150 performed dead reckoning measurements, and the initial estimated location was frequently updated as dead reckoning measurement data became available. Again, small errors in each measurement may compound each other until a larger error results.

For the example of FIG. 8, user 700 encounters staircase 810 with a most recent estimated position that is based, at least in part, on previously obtained location information from an SPS system before entering the building, and on dead reckoning measurement information as the mobile station approaches the staircase. As the user 700 begins to climb staircase 810, for this example, IMU 300 may provide sensor data, and a series of measurements may be performed. With every measurement, for this example, the estimated location may updated to reflect the motion of mobile station 150, which for this situation has horizontal and vertical components.

Once again, for an example, as dead reckoning measurements are taken, errors may accumulate, as previously described. Mobile station 150 may use known and/or estimated information related to the staircase to, at least in part, compensate for the accumulated error by adjusting the elevation component of the current estimated location. For example, in some situations, the height 820 of the individual stairs may be a known value, perhaps stored in a database such as database 640, mentioned above. If such information is available, it may be used to update the elevation component of the current estimated location as the user climbs the individual stairs. In this manner, adjustments may be made before the amount of accumulated error in the dead reckoning operations becomes relatively large, and accuracy may therefore be enhanced.

If such information as the stair height is not known, an estimated value may be used. For example, a value may be pre-calculated that may be intended to represent a typical stair, and this value may be stored in mobile station 150 for use is elevation component error compensation operations. Also, in another aspect, if no such estimated or known value for stair height is available, mobile station 150 may perform a series of measurements and calculations in an effort to determine a value for stair height that may be used for error compensation operations involving building 210. For example, as the mobile station detects the individual stairs, it may measure a height for that stair based on what IMU 300 reports as the change in elevation. Mobile station 150 may average the heights of at least two of the individual stairs, and may update that average height as additional stairs are encountered. Once user 700 reaches the top of the stairs, the total number of stairs may be multiplied by the average height of the stairs to find the total change in elevation. This change in elevation may be used to adjust the elevation component of the current estimated location in order to compensate for the accumulated error. Also, if the user has reached the top of staircase 810, floor separation value 212 may be used to adjust the elevation component of the estimated location to compensate for accumulated error.

The examples using the elevator and the staircase are merely example interior features, and the scope of claimed subject matter is not limited in these respects. Other examples are possible using any of a range other of interior features, some of which are mentioned above. Any aspect of a building that may be detected by a mobile station through sensor measurements may be used to enhance the accuracy of dead reckoning navigational operations.

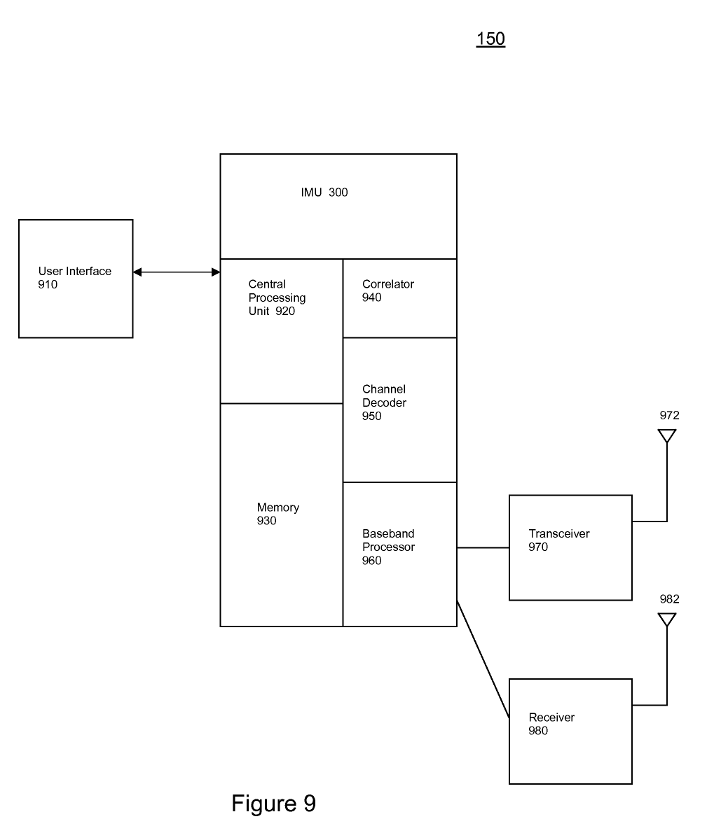

FIG. 9 is a block diagram of an example of mobile station 150. One or more radio transceivers 970 may be adapted to modulate an RF carrier signal with baseband information, such as voice or data, onto an RF carrier, and demodulate a modulated RF carrier to obtain such baseband information. An antenna 972 may be adapted to transmit a modulated RF carrier over a wireless communications link and receive a modulated RF carrier over a wireless communications link.

A baseband processor 960 may be adapted to provide baseband information from a central processing unit (CPU) 920 to transceiver 970 for transmission over a wireless communications link. Here, CPU 920 may obtain such baseband information from an input device within a user interface 910. Baseband processor 960 may also be adapted to provide baseband information from transceiver 970 to CPU 920 for transmission through an output device within user interface 910.

User interface 910 may comprise a plurality of devices for inputting or outputting user information such as voice or data. Such devices may include, by way of non-limiting examples, a keyboard, a display screen, a microphone, and a speaker.

A receiver 980 may be adapted to receive and demodulate transmissions from an SPS, and provide demodulated information to correlator 940. Correlator 940 may be adapted to derive correlation functions from the information provided by receiver 1180. Correlator 940 may also be adapted to derive pilot-related correlation functions from information relating to pilot signals provided by transceiver 970. This information may be used by a mobile station to acquire wireless communications services. Channel decoder 950 may be adapted to decode channel symbols received from baseband processor 960 into underlying source bits. In one example where channel symbols comprise convolutionally encoded symbols, such a channel decoder may comprise a Viterbi decoder. In a second example, where channel symbols comprise serial or parallel concatenations of convolutional codes, channel decoder 950 may comprise a turbo decoder.

A memory 930 may be adapted to store machine-readable instructions which are executable to perform one or more of processes, implementations, or examples thereof which are described or suggested herein. CPU 920 may be adapted to access and execute such machine-readable instructions.

Mobile station 150 for this example comprises an IMU 300, which may be adapted to perform any or all of the sensor measurement operations described herein.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “locating,” “terminating,” “identifying,” “initiating,” “detecting,” “obtaining,” “hosting,” “maintaining,” “representing,” “estimating,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium, for example. Such machine-readable instructions may comprise, for example, software or firmware stored in a storage medium included as part of a computing platform (e.g., included as part of a processing circuit or external to such a processing circuit). Further, unless specifically stated otherwise, processes described herein, with reference to flow diagrams or otherwise, may also be executed and/or controlled, in whole or in part, by such a computing platform.

Wireless communication techniques described herein may be in connection with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may comprise an IEEE 802.11x network, and a WPAN may comprise a Bluetooth network, an IEEE 802.15x, for example. Wireless communication implementations described herein may also be used in connection with any combination of WWAN, WLAN and/or WPAN.

Techniques described herein may be used with any one or more of several SPS, including the aforementioned SPS, for example. Furthermore, such techniques may be used with positioning determination systems that utilize pseudolites or a combination of satellites and pseudolites. Pseudolites may comprise ground-based transmitters that broadcast a PRN code or other ranging code (e.g., similar to a GPS or CDMA cellular signal) modulated on an L-band (or other frequency) carrier signal, which may be synchronized with GPS time. Such a transmitter may be assigned a unique PRN code so as to permit identification by a remote receiver. Pseudolites may be useful in situations where SPS signals from an orbiting satellite might be unavailable, such as in tunnels, mines, buildings, urban canyons or other enclosed areas. Another implementation of pseudolites is known as radio-beacons. The term “satellite”, as used herein, is intended to include pseudolites, equivalents of pseudolites, and possibly others. The term “SPS signals”, as used herein, is intended to include SPS-like signals from pseudolites or equivalents of pseudolites.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method, comprising:
determining an estimated initial position for a mobile station, wherein the estimated initial position comprises an elevation component;
detecting an interior feature of a building at least in part by detecting a change in position of the mobile station with respect to said estimated initial position in response to sensor data by detecting a change in the elevation component; and
adjusting the detected change in the elevation component using information related to the detected interior feature.

2. The method of claim 1, wherein the interior feature comprises one or more of a staircase, an elevator, an escalator, and/or a ramp.

3. The method of claim 2, wherein said detecting the interior feature comprises associating movement of the mobile station with movement of a user on one of the interior features.

4. The method of claim 3, wherein said adjusting the detected change in the elevation component comprises comparing the information related to the detected interior feature with information from a database related to a building associated with the estimated initial position.

5. The method of claim 3, further comprising, if the detected interior feature comprises the staircase:
detecting the change in position of the mobile station by detecting one or more vertical movements consistent with the user climbing the stairway and determining one or more vertical displacements for the one or more detected vertical movements; and
adjusting the detected change in the elevation component by averaging the one or more vertical displacements and multiplying the average by the number of vertical movements, and by adding the result to the elevation component of the estimated initial position.

6. The method of claim 3, further comprising, if the detected interior feature comprises the elevator:
detecting the change in position of the mobile station by detecting a vertical acceleration consistent with the user riding the elevator and determining a vertical displacement for the detected vertical acceleration at least in part by measuring an elapsed time; and
adjusting the detected change in the elevation component by comparing the determined vertical displacement information related to the detected interior feature with corresponding information from a database related to a building identified by location information related to the estimated initial position.

7. The method of claim 3, further comprising, if the detected interior feature comprises one of the ramp or the escalator:
detecting the change in position of the mobile station by detecting a rate of ascent consistent with the user riding the elevator and determining a vertical displacement; and
adjusting the detected change in the elevation component by comparing the determined vertical displacement information related to the detected interior feature with corresponding information from a database related to a building identified by location information related to the estimated initial position.

8. The method of claim 4, wherein said information from the database related to the building comprises one or more of a vertical distance between floors of the building, a height of an individual stair, a height of a staircase, an elevation change for a ramp, and an elevation change for an escalator.

9. The method of claim 1, the sensor data comprising data from an inertial measurement unit comprising one or more of a gyroscope and/or an accelerometer.

10. A mobile station, comprising:
a processor to determine an estimated initial position for the mobile station, wherein the estimated initial position comprises an elevation component;
an inertial measurement unit to detect an interior feature of a building at least in part by detecting a change in position of the mobile station with respect to said estimated initial position in response sensor data by detecting a change in the elevation component;
the processor being further adapted to adjust the detected change in the elevation component using information related to the detected interior structure.

11. The mobile station of claim 10, wherein the interior feature comprises one or more of a staircase, an escalator, an escalator, and/or a ramp.

12. The mobile station of claim 11, the processor being further adapted to detect the interior feature by associating movement of the mobile station with movement of a user on one of the interior features.

13. The mobile station of claim 12, the processor being further adapted to calibrate the detected change in the elevation component by comparing the information related to the detected interior feature with information from a database related to a building associated with the estimated initial position.

14. The mobile station of claim 12, wherein if the detected interior feature comprises the staircase, the processor being further adapted to detect the change in position of the mobile station by detecting one or more vertical movements consistent with the user climbing the stairway and the processor being further adapted to determine one or more vertical displacements for the one or more detected vertical movements and to adjust the detected change in the elevation component by averaging the one or more vertical displacements and multiplying the average by the number of vertical movements, and by adding the result to the elevation component of the estimated initial position.

15. The mobile station of claim 12, wherein if the detected interior feature comprises the elevator, the processor is further adapted to:
detect the change in position of the mobile station by detecting a vertical acceleration consistent with the user riding the elevator and determining a vertical displacement for the detected vertical acceleration at least in part by measuring an elapsed time; and
adjust the detected change in elevation by comparing the determined vertical displacement information related to the detected interior feature with information from a database related to a building associated with the estimated initial position.

16. The mobile station of claim 12, wherein if the detected interior feature comprises one of the ramp or the escalator, the processor is further adapted to:
detect the change in position of the mobile station by detecting a rate of ascent consistent with the user riding the elevator and determining a vertical displacement; and
adjust the detected change in the elevation component by comparing the determined vertical displacement information related to the detected interior feature with corresponding information from a database related to a building associated with the estimated initial position.

17. The mobile station of claim 13, wherein said information from the database related to the building comprises one or more of a vertical distance between floors of the building, a height of an individual stair, a height of a staircase, an elevation change for a ramp, and/or an elevation change for an escalator.

18. The mobile station of claim 10, wherein the inertial measurement unit comprises one or more of a gyroscope and/or an accelerometer.

19. An article, comprising: a storage medium having stored thereon instructions that, if executed, enable a computing platform to:
determine an estimated initial position for a mobile station, wherein the estimated initial position comprises an elevation component;
detect an interior feature of a building at least in part by detecting a change in position of the mobile station with respect to said estimated initial position in response to sensor data by detecting a change in the elevation component; and
adjust the detected change in the elevation component using information related to the detected interior feature.

20. The article of claim 19, wherein the interior feature comprises one or more of a staircase, an escalator, an escalator, and/or a ramp.

21. The article of claim 20, wherein the storage medium has stored thereon further instructions that, if executed, further enable the computing platform to detect the interior feature by associating movement of the mobile station with movement of a user on one of the interior features.

22. The article of claim 21, wherein the storage medium has stored thereon further instructions that, if executed, further enable the computing platform to adjust the detected change in the elevation component by comparing the information related to the detected interior feature with information from a database related to a building associated with the estimated initial position.

23. The article of claim 21, wherein the storage medium has stored thereon further instructions that, if executed, further enable the computing platform to, if the detected interior feature comprises the staircase:
detect the change in position of the mobile station by detecting one or more vertical movements consistent with the user climbing the stairway and determining one or more vertical displacements for the one or more detected vertical movements; and
adjust the detected change in the elevation component by averaging the one or more vertical displacements and multiplying the average by the number of vertical movements, and by adding the result to the elevation component of the estimated initial position.

24. The article of claim 21, wherein the storage medium has stored thereon further instructions that, if executed, further enable the computing platform to, if the detected interior feature comprises the elevator:
detect the change in position of the mobile station by detecting a vertical acceleration consistent with the user riding the elevator and determining a vertical displacement for the detected vertical acceleration at least in part by measuring an elapsed time; and
adjust the detected change in the elevation component by comparing the determined vertical displacement information related to the detected interior feature with corresponding information from a database related to a building identified by location information related to the estimated initial position.

25. The article of claim 22, wherein the storage medium has stored thereon further instructions that, if executed, further enable the computing platform to, if the detected interior feature comprises one of the ramp or the escalator:
detect the change in position of the mobile station by detecting a rate of ascent consistent with the user riding the elevator and determining a vertical displacement; and
adjust the detected change in the elevation component by comparing the determined vertical displacement information related to the detected interior feature with corresponding information from a database related to a building identified by location information related to the estimated initial position.

26. The article of claim 22, wherein said information from the database related to the building comprises one or more of a vertical distance between floors of the building, a height of an individual stair, a height of a staircase, an elevation change for a ramp, and an elevation change for an escalator.

27. The article of claim 19, the sensor data comprising information from an inertial measurement unit comprising one or more of a gyroscope and/or an accelerometer.

28. An apparatus, comprising:
means for determining an estimated initial position for a mobile station, wherein the estimated initial position comprises an elevation component;
means for detecting an interior feature of a building at least in part by detecting a change in position of the mobile station with respect to said estimated initial position in response to sensor data by detecting a change in the elevation component; and
means for adjusting the detected change in the elevation component using information related to the detected interior feature.

29. The apparatus of claim 28, wherein the interior feature comprises one or more of a staircase, an escalator, an escalator, and/or a ramp.

30. The apparatus of claim 29, wherein said means for detecting the interior feature comprises means for associating movement of the mobile station with movement of a user on one of the interior features.

31. The apparatus of claim 30, wherein said means for adjusting the detected change in the elevation component comprises means for comparing the information related to the detected interior feature with information from a database related to a building associated with the estimated initial position.

32. The apparatus of claim 30, further comprising, if the detected interior feature comprises the staircase:
means for detecting the change in position of the mobile station by detecting one or more vertical movements consistent with the user climbing the stairway and determining one or more vertical displacements for the one or more detected vertical movements; and
means for adjusting the detected change in the elevation component by averaging the one or more vertical displacements and multiplying the average by the number of vertical movements, and by adding the result to the elevation component of the estimated initial position.

33. The apparatus of claim 30, further comprising, if the detected interior feature comprises the elevator:
means for detecting the change in position of the mobile station by detecting a vertical acceleration consistent with the user riding the elevator and determining a vertical displacement for the detected vertical acceleration; and
means for adjusting the detected change in the elevation component by comparing the determined vertical displacement information related to the detected interior feature with corresponding information from a database related to a building identified by location information related to the estimated initial position.

34. The apparatus of claim 30, further comprising, if the detected interior feature comprises one of the ramp or the escalator:
means for detecting the change in position of the mobile station by detecting a rate of ascent consistent with the user riding the elevator and determining a vertical displacement; and
means for adjusting the detected change in the elevation component by comparing the determined vertical displacement information related to the detected interior feature with corresponding information from a database related to a building identified by location information related to the estimated initial position.

35. The apparatus of claim 31, wherein said information from the database related to the building comprises one or more of a vertical distance between floors of the building, a height of an individual stair, a height of a staircase, an elevation change for a ramp, and/or an elevation change for an escalator.

36. The apparatus of claim 28, the sensor data comprising data from an inertial measurement unit comprising one or more of a gyroscope and/or an accelerometer.
